(19) United States
(12) Patent Application Publication
(10) Pub. No.: US 2015/0076759 A1
(43) Pub. Date: Mar. 19, 2015

(54) SHEET BINDING DEVICE, SHEET PROCESSING APPARATUS, AND IMAGE FORMING SYSTEM

(71) Applicants: Katsuhiro Kosuge, Kanagawa (JP); Nobuyoshi Suzuki, Tokyo (JP); Shingo Matsushita, Tokyo (JP); Wataru Takahashi, Tokyo (JP); Yuusuke Shibasaki, Kanagawa (JP); Ryuji Yoshida, Kanagawa (JP); Takashi Saito, Kanagawa (JP); Akihiro Musha, Kanagawa (JP); Takuya Morinaga, Tokyo (JP); Ikuhisa Okamoto, Kanagawa (JP)

(72) Inventors: Katsuhiro Kosuge, Kanagawa (JP); Nobuyoshi Suzuki, Tokyo (JP); Shingo Matsushita, Tokyo (JP); Wataru Takahashi, Tokyo (JP); Yuusuke Shibasaki, Kanagawa (JP); Ryuji Yoshida, Kanagawa (JP); Takashi Saito, Kanagawa (JP); Akihiro Musha, Kanagawa (JP); Takuya Morinaga, Tokyo (JP); Ikuhisa Okamoto, Kanagawa (JP)

(73) Assignee: Ricoh Company, Ltd., Tokyo (JP)

(21) Appl. No.: 14/468,291

(22) Filed: Aug. 25, 2014

(30) Foreign Application Priority Data
Sep. 13, 2013 (JP) 2013190376

(51) Int. Cl. B65H 39/00; B65H 31/34; B42F 1/00

(52) U.S. Cl. CPC B65H 39/00; B42F 1/00; B65H 31/34
USPC 270/1.01; 270/58.07

(57) ABSTRACT

A sheet binding device includes: a pair of crimping members each including alternately-arranged multiple recesses and multiple protrusions to bind a sheaf of sheets by fitting the recesses and the protrusions with the sheet sheaf interposed therebetween. When the recesses and the protrusions of the pair of crimping members are fitted, slanted side faces of the protrusions of one of the pair of crimping members and that of the other one of the pair of crimping members are in contact with each other with a clearance left both between top portions of the protrusions of the one of the crimping members and bottom portions of the recesses of the other one of the crimping members and between top portions of the protrusions of the other one of the crimping members and bottom portions of the recesses of the one of the crimping members.

### CROSS-REFERENCE TO RELATED APPLICATIONS

The present application claims priority to and incorporates by reference the entire contents of Japanese Patent Application No. 2013-190376 filed in Japan on Sep. 13, 2013.

### BACKGROUND OF THE INVENTION

1. Field of the Invention

The present invention relates to a sheet binding device, a sheet processing apparatus, and an image forming system.

2. Description of the Related Art

Image forming systems of a conventionally known type include a sheet processing apparatus configured to bind a sheaf of sheets, on which an image is formed by an image forming apparatus, using a binding tool which is a binding unit.

International publication No. WO 2009/110298 discloses a sheet processing apparatus including a crimping-binding-type sheet binding device that binds a sheaf of sheets without using a metal staple, but by crimping the sheets by strongly engage a pair of crimping toothed jaws, which are crimping members each having a shape with protrusions and recesses, with the sheet sheaf therebetween, thereby entangling fibers of the sheets. Binding a sheet sheaf by crimping binding without using a metal staple allows saving trouble of removing the metal staple from the sheet sheaf when discarding the sheet sheaf or putting the sheet sheaf into a shredder.

FIG. 24 is a diagram illustrating a pair of crimping toothed jaws according to international publication No. WO 2009/110298. FIG. 24 is a view of the crimping toothed jaws as viewed from a direction parallel to a sheet surface of a sheet sheaf and orthogonal to a direction along which protrusions and recesses of the crimping toothed jaws are arranged.

As illustrated in FIG. 24, top portions of protrusions 172a of a lower crimping toothed jaw 261b are faces parallel to the sheet surface of the sheet sheaf. Recesses 172b of the lower crimping toothed jaw are substantially V-grooves in shape. Protrusions 171a and recesses 171b of an upper crimping toothed jaw 261a are substantially V-grooves and inverted-V-grooves, respectively, in shape.

As illustrated in FIG. 24, when the pair of crimping toothed jaws is engaged, the protrusions 171a of the upper crimping toothed jaw 261a are in contact with the recesses 172b of the lower crimping toothed jaw 261b with a clearance S left between the recesses 171b of the upper crimping toothed jaw 261a and the protrusions 172a of the lower crimping toothed jaw 261b.

According to international publication No. WO 2009/110298, when a pressure is applied to paper from above and below, the clearance S allows a load applied to fibers of the paper to be relieved as a whole and, in some parts, prevents the fibers from being extended beyond their limit, thereby allowing the fibers to be entangled without causing paper breakage. Thus, according to the disclosure, binding strength is maintained without breakage of the entire sheet.

However, in the configuration described in international publication No. WO 2009/110298, the protrusions 171a of the upper crimping toothed jaw 261a are V-shaped and have pointed top portions. This leads to a disadvantage that a pressure concentrates onto portions where the sheet sheaf contacts the top portions of the protrusions 171a of the upper crimping toothed jaw 261a and breaks sheet(s) of the sheaf.

The configuration described in international publication No. WO 2009/110298 is also disadvantageous in that breakage of sheet(s) of the sheaf can occur. This is because the clearance is formed only between the recesses 171b of the upper crimping toothed jaw 261a and the protrusions 172a of the lower crimping toothed jaw 261b, fibers are not sufficiently prevented from being extended beyond their limit.

In light of the foregoing, there is a need for a sheet binding device, a sheet processing apparatus, and an image forming system capable of reducing damage to a sheet(s).

### SUMMARY OF THE INVENTION

It is an object of the present invention to at least partially solve the problems in the conventional technology.

A crimping-binding-type sheet binding device includes: a pair of crimping members each including alternately-arranged multiple recesses and multiple protrusions, the protrusions and the recesses of one of the pair of crimping members being arranged in a direction parallel to a direction in which the protrusions and the recesses of other one of the pair of crimping members are arranged, to bind a sheaf of sheets by fitting the recesses and the protrusions with the sheet sheaf interposed therebetween. The pair of crimping members are configured in such a manner that top portions of the protrusions of each of the pair of crimping members are faces parallel to a sheet surface of the sheet sheaf, side faces of the protrusions of each of the pair of crimping members are slanted faces slanted relative to the sheet surface, and when the recesses and the protrusions of the pair of crimping members are fitted, the slanted faces of the one of the pair of crimping members and the slanted faces of the other one of the pair of crimping members are in contact with each other with a clearance left both between the top portions of the protrusions of the one of the crimping members and bottom portions of the recesses of the other one of the crimping members and between the top portions of the protrusions of the other one of the crimping members and bottom portions of the recesses of the one of the crimping members.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are schematic configuration diagrams each illustrating an example of an overall configuration of an image forming system according to an embodiment of the present invention;

FIG. 2 is a schematic configuration diagram illustrating an example configuration of an image forming apparatus of the image forming system according to the embodiment;

FIG. 3 is a plan view illustrating an example configuration of a sheet processing apparatus of the image forming system according to the embodiment;

FIG. 4 is a front view of the sheet processing apparatus illustrated in FIG. 3;

FIG. 5 is an explanatory diagram illustrating a bifurcating claw, which selectively directs a sheet conveyed into the sheet processing apparatus, at a home position;

FIG. 6 is an explanatory diagram illustrating the bifurcating claw at a position for directing a sheet conveyed into the sheet processing apparatus to a branch path;

FIG. 7 is an explanatory diagram illustrating an example of a binding tool and a drive mechanism of the binding tool in a state where toothed jaws are open;

FIG. 8 is an explanatory diagram illustrating the example of the binding tool and the drive mechanism of the binding tool in a state where the toothed jaws are closed;

FIGS. 9A and 9B are a plan view and a front view, respectively, showing the internal of the sheet processing apparatus at completion of initialization;

FIGS. 10A and 10B are a plan view and a front view, respectively, showing the internal of the sheet processing apparatus receiving a sheet thereinto;

FIGS. 11A and 11B are a plan view and a front view, respectively, showing the internal of the sheet processing apparatus positioning the sheet in a sheet width direction;

FIGS. 12A and 12B are a plan view and a front view, respectively, showing the internal of the sheet processing apparatus positioning a trailing end of the sheet;

FIGS. 13A and 13B are a plan view and a front view, respectively, showing the internal of the sheet processing apparatus receiving a subsequent sheet thereinto;

FIGS. 14A and 14B are a plan view and a front view, respectively, showing the internal of the sheet processing apparatus receiving a next subsequent sheet thereinto;

FIGS. 15A and 15B are a plan view and a front view, respectively, showing the internal of the sheet processing apparatus in a state where a sheet sheaf has been aligned but a binding process is not started yet;

FIGS. 16A and 16B are a plan view and a front view, respectively, showing the internal of the sheet processing apparatus at start of discharging the sheet sheaf having undergone the binding process;

FIGS. 17A and 17B are a plan view and a front view, respectively, showing the internal of the sheet processing apparatus discharging the sheet sheaf having undergone the binding process;

FIGS. 18A to 18D are explanatory diagrams of a crimping binding method;

FIG. 19 is a plan view of a lower crimping toothed jaw;

FIG. 20 is a diagram of the lower crimping toothed jaw as viewed in a direction A of FIG. 19;

FIG. 21 is a diagram of the lower crimping toothed jaw as viewed in a direction B of FIG. 19;

FIGS. 22A and 22B are diagrams describing behavior of the sheet sheaf during crimping binding;

FIG. 23 is a graph illustrating a result of a verification test; and

FIG. 24 is a diagram illustrating a conventional pair of crimping toothed jaws.

### DETAILED DESCRIPTION OF THE PREFERRED EMBODIMENTS

Exemplary embodiments of the present invention are described below with reference to the accompanying drawings.

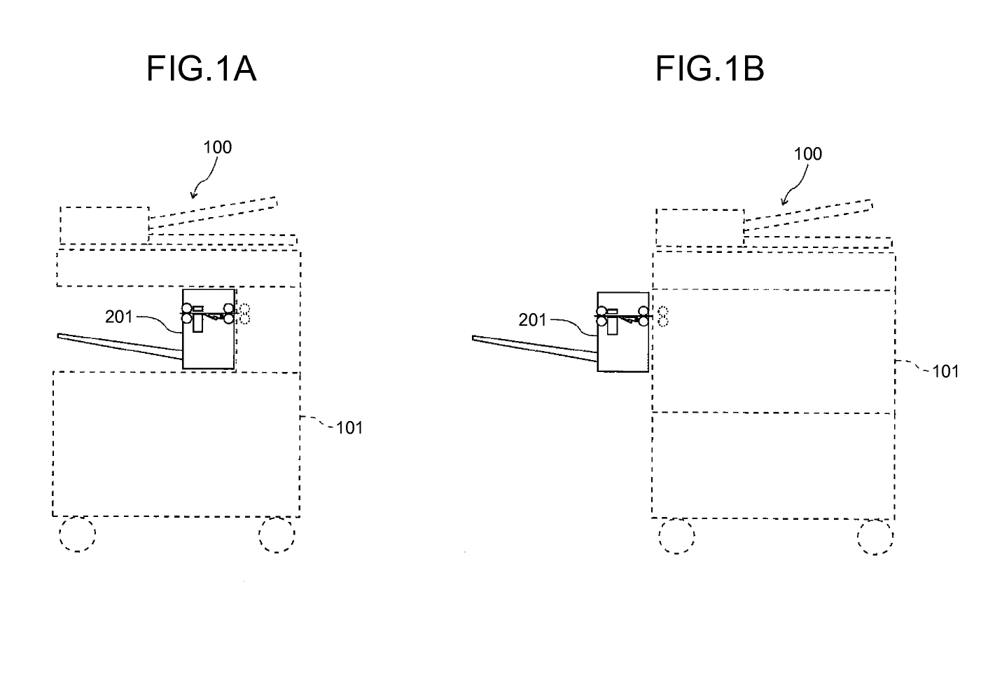

FIGS. 1A and 1B are schematic configuration diagrams each illustrating an example of an overall configuration of an image forming system according to an embodiment of the present invention. FIG. 1A illustrates an image forming system 100 having an example configuration in which a sheet processing apparatus 201 is incorporated in an image forming apparatus 101 serving as an image forming device which forms an image on a sheet of paper based on an input image. FIG. 1B illustrate another example configuration of the image forming system 100 in which the sheet processing apparatus 201 is connected to the image forming apparatus 101.

The image forming system 100 according to the embodiment electrophotographically forms an image, which is a toner image, on a sheet. Alternatively, the image forming system 100 may form an image by other method such as an inkjet method. In the embodiment, an image forming apparatus configured as the image forming apparatus 101 combined with the sheet processing apparatus 201 is described, but not limited thereto. The present invention is applicable to an image forming apparatus configured as the image forming apparatus 101 in which the sheet processing apparatus 201 is built.

The present invention is also applicable to a configuration in which the sheet processing apparatus 201 is independent of the image forming apparatus 101. When this independent design is employed, the sheet processing apparatus may include a cassette or a tray where sheets to be bound are to be placed and a tray onto which a sheet sheaf(s) is to be output.

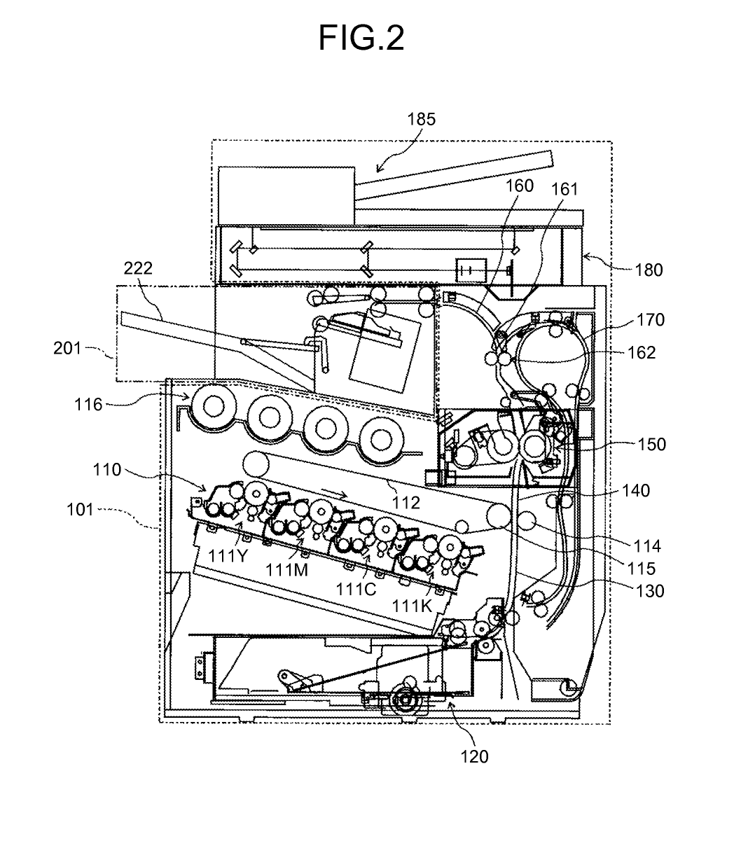

FIG. 2 is a schematic configuration diagram illustrating an example configuration of the image forming system 100 according to the embodiment.

Referring to FIG. 2, the image forming system 100 is a tandem color image forming apparatus adopting an indirect transfer scheme with use of an intermediate transfer member. An image forming unit 110 serving as a toner-image forming unit is arranged at substantially center of the image forming apparatus 101. The image forming unit 110 includes image forming stations 111Y, 111M, 111C, and 111K for four colors (Y: yellow, M: magenta, C: cyan, and K: black) arranged in a predetermined direction. Hereinafter, suffixes Y, M, C, and K are omitted as appropriate.

The image forming apparatus 101 further includes multiple sheet feeding trays 120 which are sheet feeding units serving as recording-medium supplying units. The sheet feeding trays 120 are arranged under the image forming unit 110. The image forming apparatus 101 further includes a sheet-feeding conveying path (vertical conveying path) 130 for conveying a sheet, which is a recording medium, picked up from the sheet feeding tray 120 to a secondary transfer unit 140 and a fixing unit 150. The image forming apparatus 101 further includes a branch sheet discharging path 160 for conveying a sheet, onto which an image (toner image) is fixed, to the sheet processing apparatus 201 and a duplex-printing conveying path 170 for turning a sheet, on a first side (front side) of which an image (toner image) is formed, upside down so that an image is formed on a second side (back side).

The image forming apparatus 101 further includes a scanner unit 180 serving as an image reading unit and an automatic document feeder (ADF) 185 serving as an original-document supplying unit. The scanner unit 180 reads an image of an original document (hereinafter, “document”), which is an image-reading subject, placed on a glass surface serving as a document table and converts the image into an electric signal. One or more sheets of the document to be read by the scanner unit 180 are placed in the ADF 185. The ADF 185 conveys each sheet of the document to the glass surface which is at a reading position of the scanner unit 180.

The image forming unit 110 includes photosensitive drums as image bearers for the respective colors (Y, M, C, and K) of the image forming stations 111. An electrostatic charger unit, a developing unit, a primary transfer unit, a cleaning unit, and an electrostatic discharging unit are arranged around and along the outer periphery of each of the photosensitive drums. The image forming unit 110 includes an optical writing unit (not shown) serving as an exposure unit and an intermediate transfer belt 112 serving as an intermediate transfer member. The optical writing unit is arranged under the image forming stations 111 and emits light onto each of the photosensitive drums according to image data generated for each of the colors based on a reading result output from the scanner unit 180, thereby forming electrostatic latent images. The intermediate transfer belt 112 is arranged above the image forming stations 111. Images (toner images) formed on the photosensitive drums are transferred onto the intermediate transfer belt 112 by the primary transfer unit.

The intermediate transfer belt 112 is rotatably supported by multiple support rollers. A support roller 114, which is one of the support rollers, faces a secondary transfer roller 115 in the secondary transfer unit 140 with the intermediate transfer belt 112 therebetween. The images (toner images) on the intermediate transfer belt 112 are transferred, as secondary transfer, onto a sheet in the secondary transfer unit 140. Replaceable toner containers 116 are arranged above the intermediate transfer belt 112.

Meanwhile, an image forming process performed by such an image forming apparatus configured as described above (tandem color image forming apparatus adopting the indirect transfer method) is known and does not have direct relation with the gist of the present invention. Accordingly, detailed description is omitted.

The sheet, onto which the image is fixed by the fixing unit 150, is conveyed by conveying rollers 162. A conveying direction of the sheet is switched by a conveying-path switching member 161. Thereby, the image-fixed sheet is conveyed to one of the branch sheet discharging path 160 and the duplex-printing conveying path 170.

The sheet processing apparatus 201 according to the embodiment includes a conveying-path binding mechanism as a sheet binding unit which, as postprocessing for multiple sheets including one or more image-formed sheets, binds a sheaf of the multiple sheets. The conveying-path binding mechanism includes a structure for stacking sheets and aligning the sheets on the sheet conveying path, and a binding tool serving as a binding unit which binds the stacked sheets.

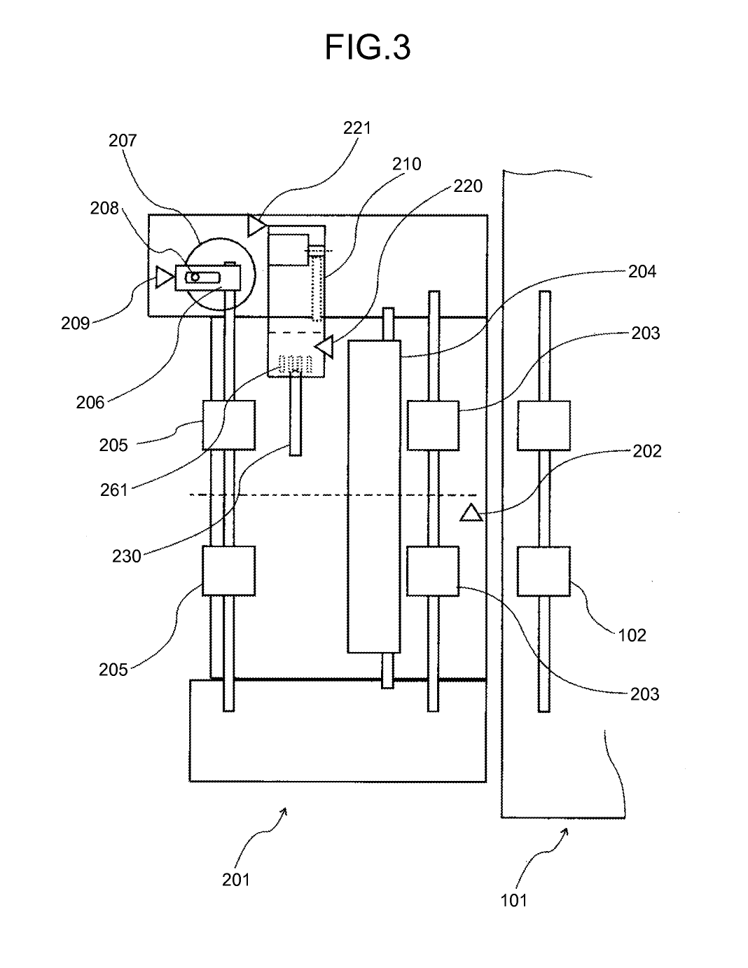

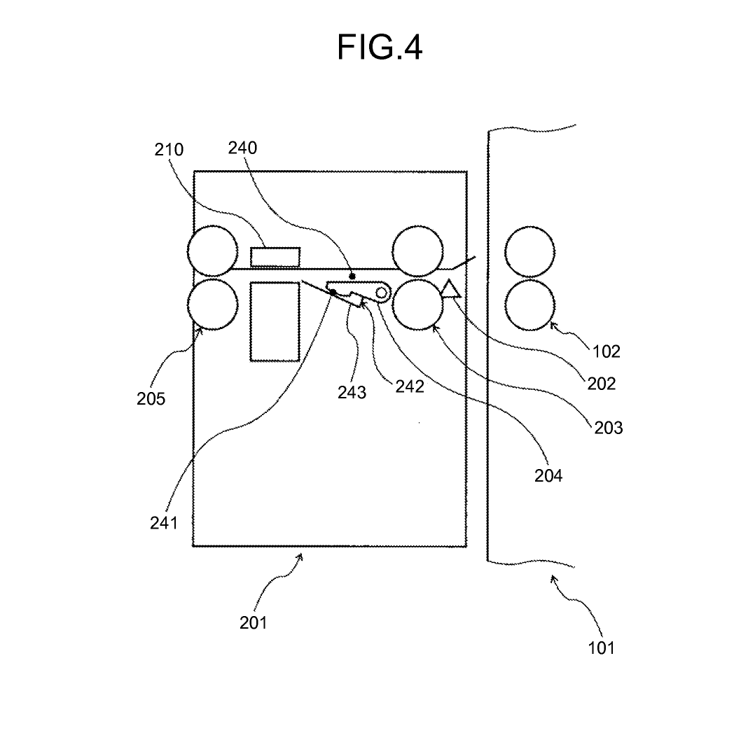

FIG. 3 and FIG. 4 are a plan view and a front view, respectively, illustrating an example configuration of the sheet processing apparatus 201, which is included in the image forming system 100, including the conveying-path binding mechanism.

The sheet processing apparatus 201 includes an entry sensor 202, entry rollers 203, a bifurcating claw (switching claw) 204, sheet discharging rollers 205, a shift link 206, a shift cam 207, a shift cam stud 208, a shift home position (HP) sensor 209, and a binding tool 210.

The entry sensor 202 detects a leading end, a trailing end, and presence/absence of a sheet conveyed by sheet discharging rollers 102 of the image forming apparatus 101 into the sheet processing apparatus 201.

The entry rollers 203 are arranged at an entry port of the sheet processing apparatus 201 and have a function of conveying a sheet into the sheet processing apparatus 201. Furthermore, abutment skew correction can be applied to a sheet by using a nip between the entry rollers 203. The entry rollers 203 are driven by a controllable driving source (not shown). The driving source is controlled by a controller (not shown) which controls rotation and stop of the entry rollers 203 and a conveyance amount of a sheet by the entry rollers 203. The controller may be provided in the image forming apparatus 101.

The bifurcating claw 204 is a pivotable claw provided to switch a conveying path so that a trailing end of a sheet is guided to a branch path 241. The bifurcating claw 204 is configured to be capable of pressing the sheet against a conveyance surface of the branch path to immobilize the sheet by pressing the sheet in this manner.

The sheet discharging rollers 205 are arranged at an exit port of the sheet processing apparatus 201 and have a function of conveying, shifting, and discharging a sheet. The sheet discharging rollers 205 are driven by a controllable driving source (not shown). The driving source is controlled by a controller which will be described later and which controls rotation and stop of the sheet discharging rollers 205 and a conveyance amount of a sheet by the sheet discharging rollers 205.

A conveying unit for conveying a sheet in the sheet processing apparatus 201 of the embodiment is made up of, for example, the entry rollers 203, the sheet discharging rollers 205, and the driving sources driving the rollers 203 and 205.

The shift link 206 is provided at a shaft end of the sheet discharging rollers 205 and is a part which receives a moving force for the shifting function.

The shift cam 207 including the shift cam stud 208 is a rotatable disc-like component. Rotation of the shift cam 207 shifts the sheet discharging rollers 205, which are connected to an elongated hole in the shift link 206 via the shift cam stud 208.

The shift cam stud 208 interlocked with the elongated hole in the shift link 206 converts a circular motion of the shift cam 207 into a linear motion in an axial direction of the sheet discharging rollers 205.

The shift HP sensor 209 detects a position of the shift link 206. The detected position is defined as a home position (standby position).

The binding tool 210 is a tool or a device configured to bind a sheet sheaf together by a squeezing and crimping process without using a metal staple. The embodiment employs the binding tool 210 which pinches a sheaf of sheets between a pair of toothed jaws made up of an upper toothed jaw and a lower toothed jaw each having protrusions and recesses on its surface, thereby deforming the sheets and entangling fibers of the sheets. As the binding tool 210 of this type, a known binding tool disclosed in, for example, Japanese Examined Utility Model Publication No. S36-13206 can be used. A binding tool of another type may be used which binds a sheet sheaf without using a metal staple by cutting and bending a U-shaped or tongue-shaped notch in the sheet sheaf, simultaneously cutting a slit near a basal portion of the tongue, and passes a distal end portion of the tongue through the slit in a manner not to easily come out of the slit. An example of a binding tool of this type is disclosed in Japanese Examined Utility Model Publication No. S37-007208. Note that the binding unit for binding a sheet sheaf is not limited to the binding tool of the embodiment. Any binding unit which binds a sheaf of sheets by crimping the sheet sheaf to thereby entangle fibers of the sheets can be used.

A sheet edge sensor 220 serving as a sheet-edge detecting unit is a sensor which detects a side edge of a sheet. Sheet alignment is performed with reference to a position detected by the sheet edge sensor 220.

A binding-tool HP sensor 221 is a sensor which detects a position of the binding tool 210 that is movable in a width direction crossing the sheet conveying direction. A position where, even when a sheet of a maximum size is fed, the binding tool 210 does not interfere with the sheet is set as a home position (standby position), and this position is detected by the binding-tool HP sensor 221.

A binding-tool guide rail 230 guides movement of the binding tool 210 so that the binding tool 210 can move in the sheet width direction stably.

A conveying path 240 is a regular path for conveying and discharging a sheet conveyed into the sheet processing apparatus 201. The branch path 241 is a conveying path provided to stack and align sheets. A sheet is conveyed backward onto the branch path 241 in such a manner that a trailing end of the sheet enters the branch path 241 first.

A binding tray (staple tray) 243 is a sheet tray serving as a sheet container where sheets to be bound are housed. An abutment surface 242 is a reference surface against which trailing ends of the sheets in the binding tray 243 are brought into abutment for alignment. In the embodiment, for example, crimping toothed jaws 261 are a pair of toothed jaws having shapes with protrusions and recesses which mesh with each other. The crimping toothed jaws 261 pinch sheets therebetween, thereby deforming the sheets and entangling fibers of the sheets.

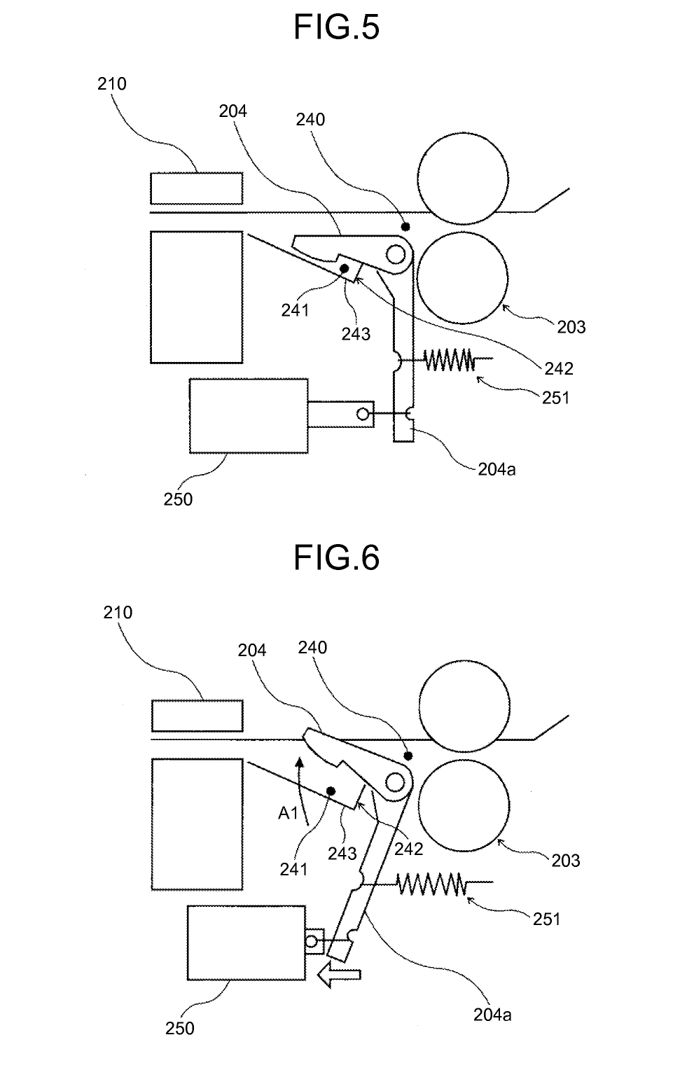

FIGS. 5 and 6 are explanatory diagrams illustrating an example configuration of the bifurcating claw 204, which selectively directs a sheet conveyed into the sheet processing apparatus 201, and elements around the bifurcating claw 204 in detail. FIG. 5 is an explanatory diagram illustrating a home position of the bifurcating claw 204. FIG. 6 is an explanatory diagram illustrating the bifurcating claw at a position for directing a sheet conveyed into the sheet processing apparatus 201 to the branch path 241.

The bifurcating claw 204 is configured to be pivotable to switch between the conveying path 240 and the branch path 241. As illustrated in FIG. 5, a position at which a sheet conveyed from the right of FIG. 5 can be conveyed without resistance is set as the home position of the bifurcating claw 204. The bifurcating claw 204 is constantly pressed by a spring 251 as illustrated in FIG. 5. The spring 251 is hooked onto a bifurcating-claw moving lever 204a. A bifurcating solenoid 250 is also coupled to the bifurcating-claw moving lever 204a via a link. The conveying surface of the branch path 241 and the bifurcating claw 204 are configured to be capable of pinching a sheet therebetween on the conveying path. Switching of the conveying path is performed such that, when the bifurcating solenoid 250 is switched on, the bifurcating claw 204 is rotated in a direction indicated by arrow A1 in FIG. 6 to close the conveying path 240 and guide a sheet to the branch path 241.

In the embodiment, a unit which stacks multiple sheets to be bound to form a sheet sheaf is made up of the entry rollers 203, the sheet discharging rollers 205, the bifurcating claw 204, the binding tray 243 including the abutment surface 242, and the driving sources driving these elements.

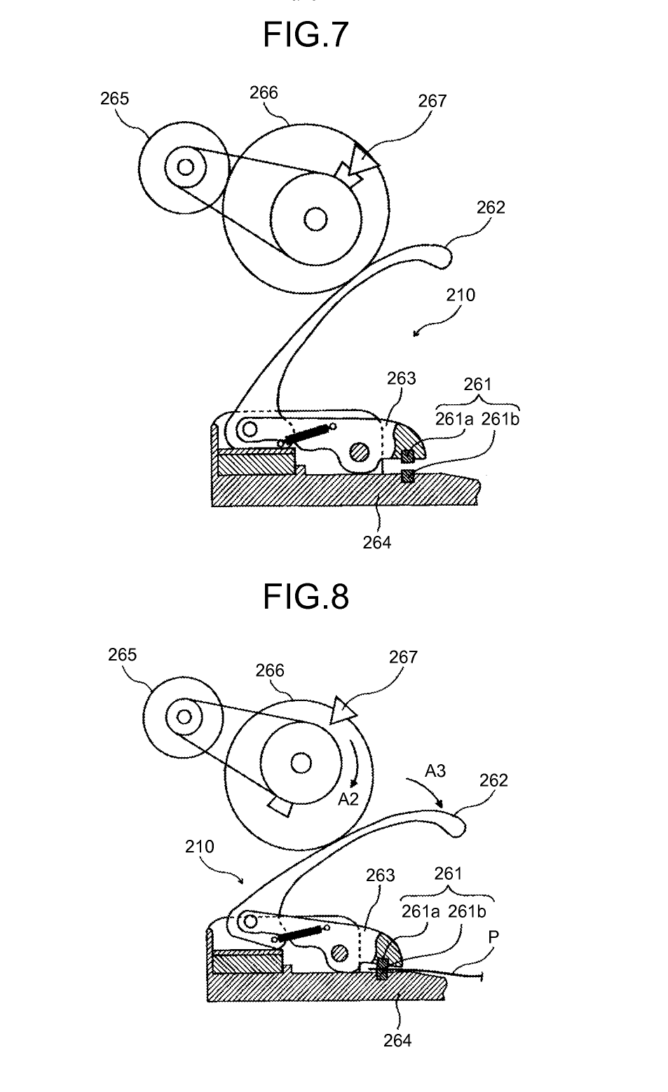

FIGS. 7 and 8 are explanatory diagrams illustrating an example of configuration and operations of the binding tool 210. FIG. 7 is an explanatory diagram illustrating an example of the binding tool 210 and a drive mechanism of the binding tool 210 in a state where the crimping toothed jaws 261 are open. FIG. 8 is an explanatory diagram illustrating the example of the binding tool 210 and the drive mechanism of the binding tool 210 in a state where the crimping toothed jaws 261 are closed. Note that the configuration of the binding tool 210 is not limited to that illustrated in FIGS. 7 and 8.

Referring to FIG. 7, the crimping toothed jaws 261 includes the upper crimping toothed jaw 261a and the lower crimping toothed jaw 261b formed to mesh with each other. The upper crimping toothed jaw 261a is assembled onto a distal end of a movable link member 263. The lower crimping toothed jaw 261b is assembled onto a stationary link member 264 in a manner to face the upper crimping toothed jaw 261a. The movable link member 263 is configured in such a manner that pivoting motion of a pressing lever 262 moves the crimping toothed jaws 261 toward and away from each other. The pressing lever 262 is pivoted in a direction indicated by arrow A3 in FIG. 8 by a cam 266 which rotates in a direction indicated by arrow A2 in FIG. 8. The cam 266 is controlled so as to be rotated by a driving force fed from a drive motor 265 and situated at a detection position based on detection information output of the cam HP sensor 267. The detection position where the cam 266 is detected by the cam HP sensor 267 is defined as a home position (standby position) of the cam 266. At this position, the crimping toothed jaws 261 are in the open state.

Operation is made as shown in FIG. 8 when sheets are bound. Sheets P are interposed between the pair of crimping toothed jaws 261 in the open state. The cam 266 is rotated in the direction indicated by arrow A2 in FIG. 8 by rotation of the drive motor 265. The cam surface of the cam 266 is displaced, causing the pressing lever 262 to pivot in the direction indicated by arrow A3 in FIG. 8. Rotating force of the pressing lever 262 is multiplied via the movable link member 263 that utilizes leverage, and transmitted to the upper crimping toothed jaw 261a which is at the end of the movable link member 263. At a point in time where the cam 266 has rotated a certain degree, the upper crimping toothed jaw 261a and the lower crimping toothed jaw 261b are engaged with each other and pinch the sheets P therebetween. By being pinched in this way, the sheets P are deformed and pressed, and fibers in adjacent sheets are entangled. The sheets P are thus bound together. Thereafter, the drive motor 265 is rotated backward, and stopped at the detection position where the cam 266 is detected by the cam HP sensor 267. The pressing lever 262, which has resilience, is deformed when an excessive load is placed on the pressing lever 262, thereby relieving the excessive load.

In the binding tool 210 configured as illustrated in FIGS. 7 and 8, a binding strength, at which the sheets P are bound by entanglement of fibers of the sheets, changes with a binding force, which is an engaging force at which the pair of crimping toothed jaws 261 are engaged with each other and pinch the sheets P to thereby deform and press the sheets P. The binding force being the force by which the pair of crimping toothed jaws 261 are engaged varies with a rotating force (torque) at which the pressing lever 262 is pivoted via the cam 266 or, in other words, a torque (the moment of a force) generated by the drive motor 265. The torque generated by the drive motor 265 varies with an electric current supplied to the drive motor 265. Accordingly, it is possible to change the binding force of the binding tool 210 to thereby change the binding strength of the sheet sheaf according to a binding mode, such as a permanent binding mode or a temporary binding mode, by controlling the electric current supplied to the drive motor 265.

An example of a binding operation performed by the sheet processing apparatus 201 is described below.

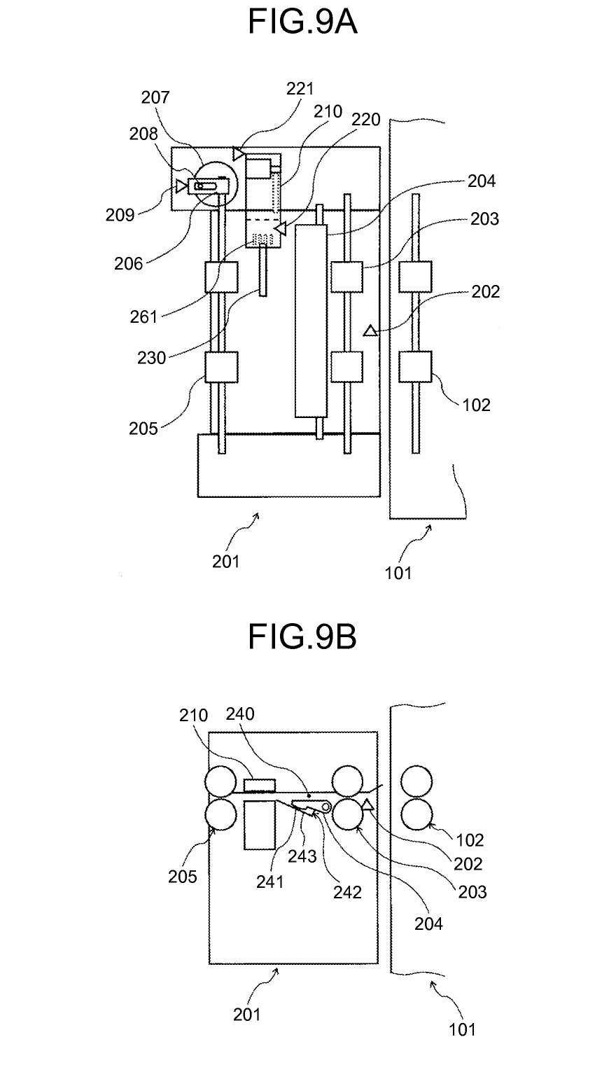

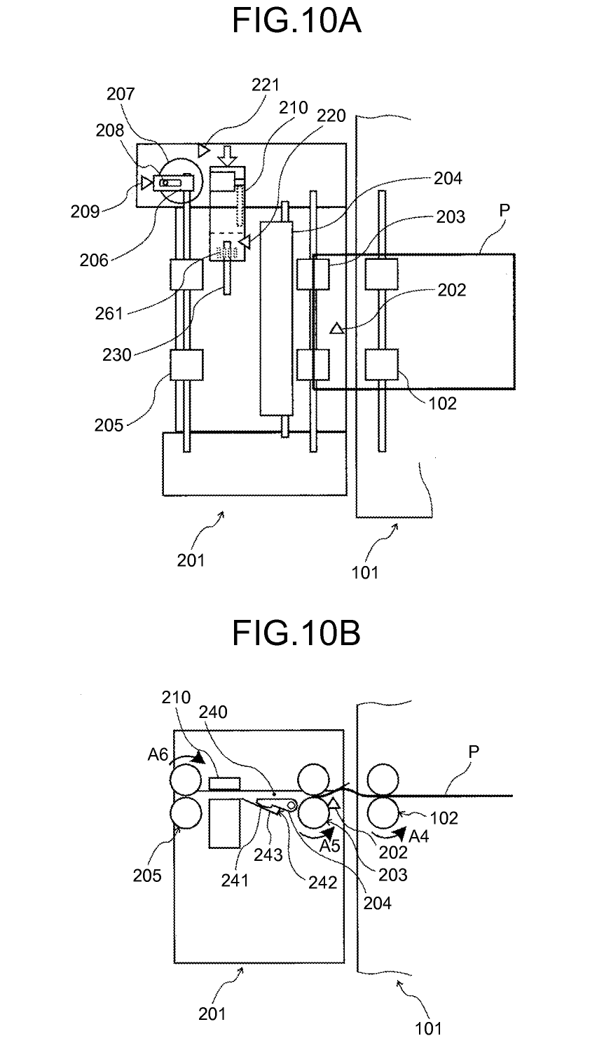

FIGS. 9A to 17B are plan views and front views of the sheet processing apparatus 201 performing the example binding operation. FIGS. 9A, 10A, . . . , and 17A are plan views of the sheet processing apparatus 201. FIGS. 9B, 10B, . . . , and 17B are front views of the sheet processing apparatus 201.

Referring to FIGS. 9A and 9B, when the image forming apparatus 101 starts discharging a sheet, the units of the sheet processing apparatus 201 move to their home positions to complete initialization.

Subsequently, referring to FIGS. 10A and 10B, before the sheet P discharged from the image forming apparatus 101 is conveyed into the sheet processing apparatus 201, the sheet processing apparatus 201 receives information about an operation mode and information about the sheet P and enters a receipt-standby state based on the received information. The operation mode in the embodiment is any one of a straight mode, a shift mode, and a binding mode; however, it is not limited thereto.

Operation of the sheet processing apparatus 201 in the straight mode and that in the shift mode are described below.

How the sheet processing apparatus 201 operates in the straight mode is described first.

Upon receiving information indicating the straight mode and information about the sheet P, the sheet processing apparatus 201 enters a receipt-standby state for the straight mode. More specifically, each of the pair of entry rollers 203 and sheet discharging driving rollers 205a starts rotating in a predetermined rotating direction so that the sheet P conveyed into the sheet processing apparatus 201 is conveyed in a predetermined conveying direction (to the left in the drawing). The sheet P is fed into the sheet processing apparatus 201 in this receipt-standby state by rotation of the sheet discharging rollers 102 of the image forming apparatus 101. The sheet P fed into the sheet processing apparatus 201 is conveyed by the pair of entry rollers 203 and then by a pair of sheet discharging rollers, which is made up of the sheet discharging driving rollers 205a and sheet discharging driven rollers 205b, and discharged. When a last sheet has been discharged, the pair of entry rollers 203 and the sheet discharging driving rollers 205a are stopped.

How the sheet processing apparatus 201 operates in the shift mode is described below.

Upon receiving information indicating the shift mode and information about the sheet P, the sheet processing apparatus 201 enters a receipt-standby state for the shift mode. More specifically, each of the pair of entry rollers 203 and the sheet discharging driving rollers 205a starts rotating in the predetermined rotating direction so that the sheet P conveyed into the sheet processing apparatus 201 is conveyed in the predetermined conveying direction (to the left in the drawing) as in the straight mode. The sheet P is fed from the image forming apparatus 101 into the sheet processing apparatus 201 in this receipt-standby state. The sheet fed into the sheet processing apparatus 201 is conveyed by the pair of entry rollers 203 and the pair of sheet discharging rollers as in the straight mode. Subsequently, when a trailing end of the sheet has exited the pair of entry rollers 203, the shift cam 207 is rotated a predetermined degree. As a result, the sheet discharging driving rollers 205a are moved in their axial direction. The sheet P is moved together with the sheet discharging driving rollers 205a. When the sheet P has been discharged, the shift cam 207 rotates to return to its home position to receive a next sheet. This operation of the sheet discharging driving rollers 205a is repeatedly performed until all sheets belonging to the same “stack” have been discharged. When a sheet belonging to a next “stack” is conveyed into the sheet processing apparatus 201, the shift cam 207 rotates in a direction opposite to the previous direction, and the sheet is shifted to the opposite side and discharged.

Upon receiving information indicating the binding mode and information about the sheet P, the sheet processing apparatus 201 enters a receipt-standby state for the binding mode. More specifically, in the receipt-standby state for the binding mode, the pair of entry rollers 203 are stopped, and the sheet discharging driving rollers 205a start rotating in a direction indicated by arrow A6 in the drawing so that the sheet P fed into the sheet processing apparatus 201 is conveyed in the predetermined conveying direction (to the left in the drawing). The binding tool 210 moves to its standby position (home position) away from an end of the sheet P in the width direction a preset distance and enters a standby state.

Thereafter, when the sheet P is conveyed into the sheet processing apparatus 201, a leading end of the sheet P is detected by the entry sensor 202. The sheet P is conveyed a predetermined distance (being a distance which brings the leading end of the sheet P into abutment with the nip between the entry rollers 203 and resiliently deforms the sheet P a predetermined degree) from when the leading end is detected by the entry sensor 202. After the sheet P is conveyed the predetermined distance, the entry rollers 203 start rotating. Skew correction of the sheet P is performed in this manner.

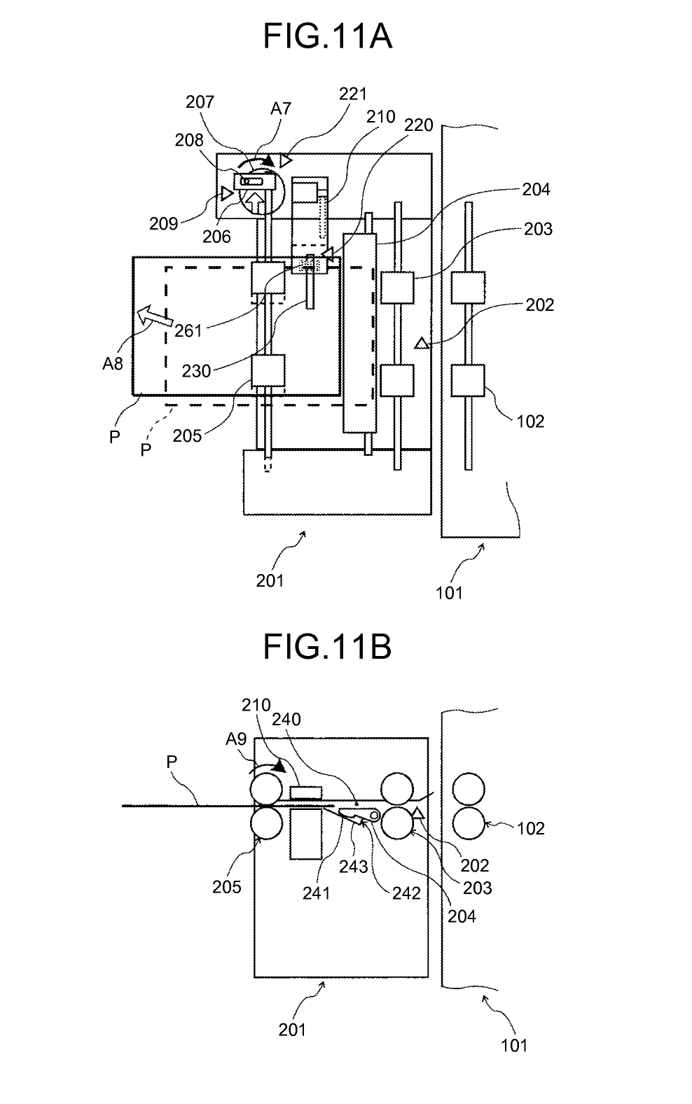

Referring to FIGS. 11A and 11B, a conveyed distance of the sheet P is counted based on detection information output from the entry sensor 202 on detection of the trailing end of the sheet P. Positional information about the sheet P is obtained in this way. When the trailing end of the sheet P has exited the nip between the entry rollers 203, the entry rollers 203 stop rotating to receive a next sheet. Concurrently therewith, the shift cam 207 rotates in a direction indicated by arrow A7 (clockwise) in the drawing, causing the sheet discharging rollers 205 to start moving in their axial direction together with the sheet P. As a result, the sheet P is conveyed obliquely in a direction indicated by arrow A8 in the drawing. Thereafter, when the sheet P is detected by the sheet edge sensor 220 attached to or built in the binding tool 210, the shift cam 207 stops rotating, and then rotates backward. This backward rotation of the shift cam 207 stops when the sheet P becomes not detected by the sheet edge sensor 220 anymore. When the operation described above is completed and the trailing end of the sheet reaches a predetermined position where the trailing end has passed over a distal end of the bifurcating claw 204, rotation of the sheet discharging rollers 205 in the direction indicated by arrow A9 in the drawing is stopped.

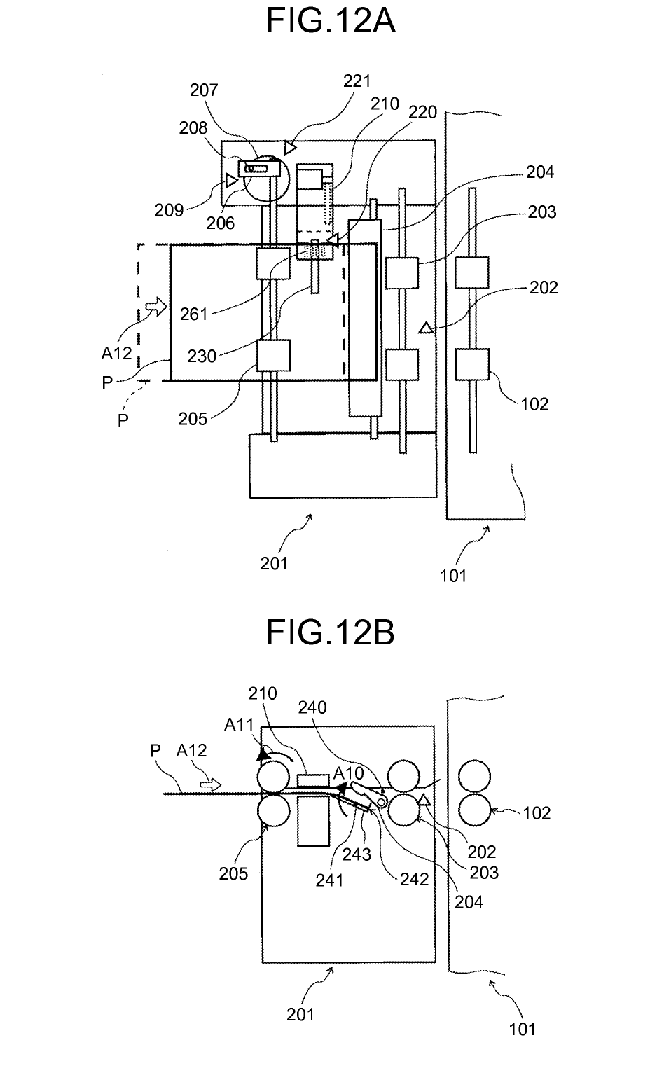

Subsequently, referring to FIGS. 12A and 12B, the bifurcating claw 204 is rotated in a direction indicated by arrow A10 (clockwise) in the drawing to switch the conveying path. Thereafter, the sheet discharging rollers 205 rotate in a direction indicated by arrow A11 (counterclockwise) in the drawing to convey the sheet P in a direction indicated by arrow A12 the drawing so that the trailing end of the sheet P is conveyed onto the branch path 241. By being conveyed in this manner, the sheet P is brought into abutment against the abutment surface 242 of the binding tray 243 and aligned. The sheet discharging rollers 205 then stop. The sheet discharging rollers 205 are configured to have a weak conveying force so as to slip after the sheet P is brought into abutment.

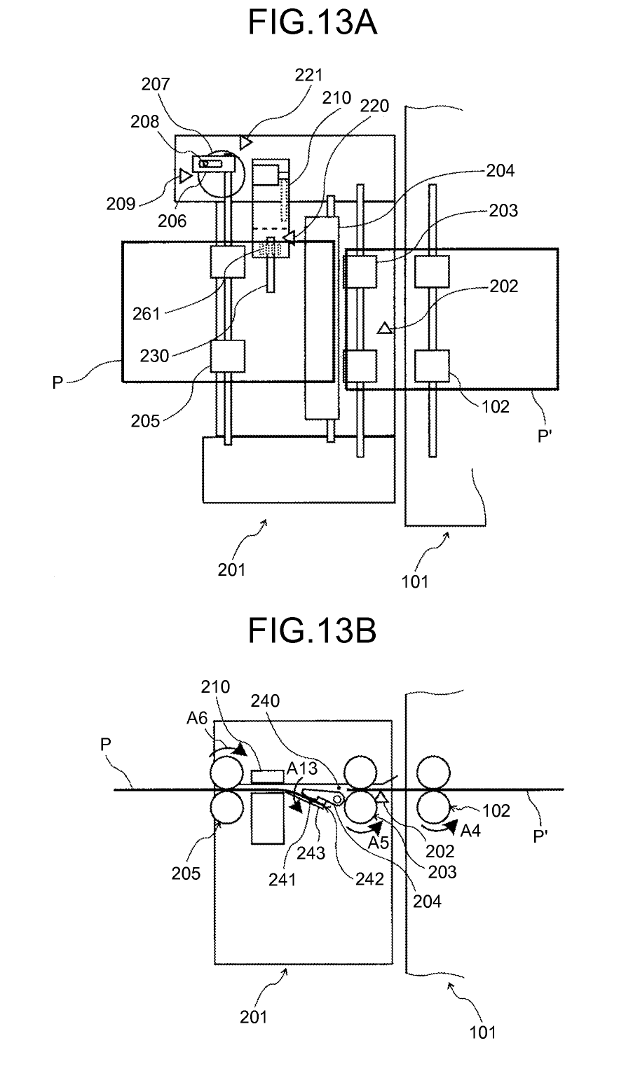

Subsequently, referring to FIGS. 13A and 13B, the bifurcating claw 204 is rotated in a direction indicated by arrow A13 (counterclockwise) in the drawing. The sheet P on the branch path 241 is on standby with the trailing end of the sheet P firmly pressed by the bifurcating claw 204 at a contact surface where the bifurcating claw 204 contacts the sheet P. When a following sheet P′ is conveyed out from the image forming apparatus 101, the entry rollers 203 apply skew correction to the sheet P′ as in the case of the sheet P. Concurrently when the entry rollers 203 start rotating, the sheet discharging rollers 205 start rotating in the sheet-conveying rotating direction (the direction indicated by arrow A6 in the drawing).

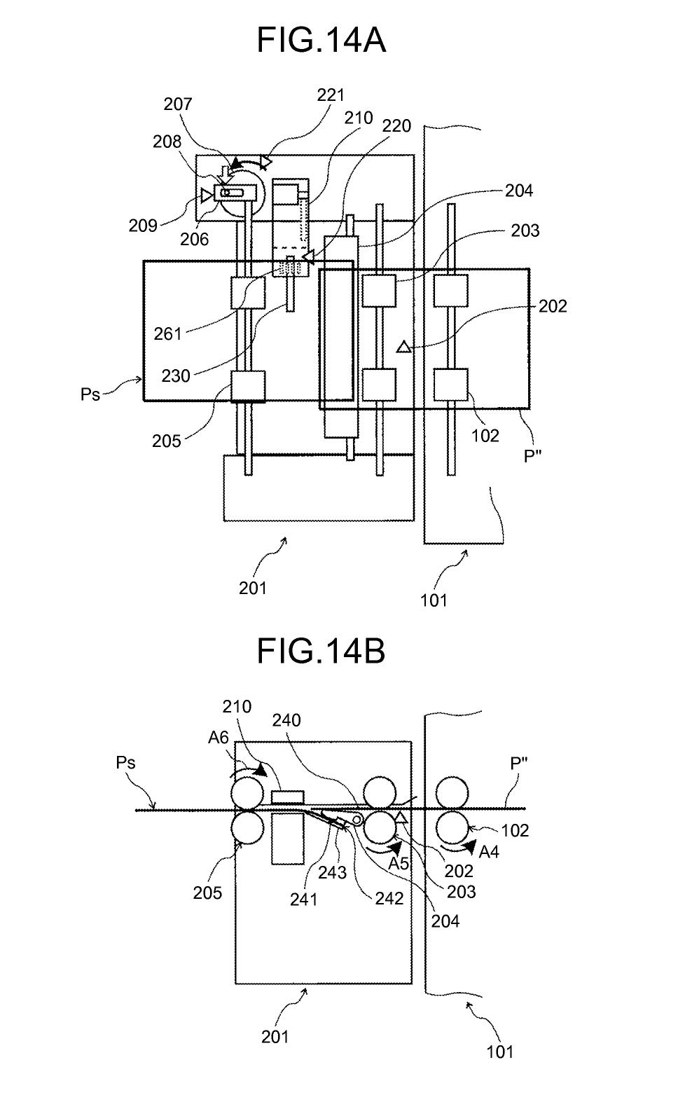

Referring to FIGS. 14A and 14B, the operation illustrated in FIGS. 11A to 12B described above is performed on each of the second and following sheets P″, . . . , to move the sheets one sheet by one sheet to the intended position and stack the sheets, thereby stacking an aligned sheet sheaf Ps on the conveying path.

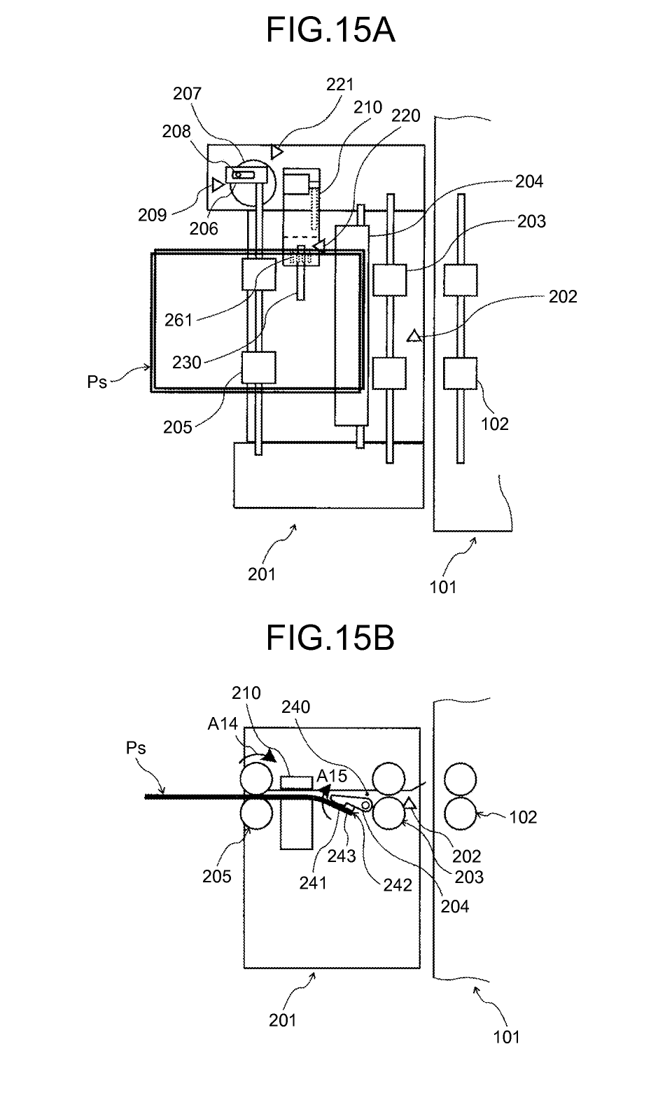

Referring to FIGS. 15A and 15B, when a last sheet has been stacked on the aligned sheet sheaf Ps, the sheet discharging rollers 205 rotate in the direction indicated by arrow A14 (clockwise) in the drawing to convey the sheet sheaf Ps a predetermined distance, and stop. This motion of the sheet discharging rollers 205 can cancel the deformation of the sheets caused when the trailing ends of the sheets are brought into abutment against the abutment surface 242. Thereafter, the bifurcating claw 204 is rotated in the direction indicated by arrow A15 (clockwise) in the drawing. As a result, orientation of the distal end of the bifurcating claw 204 is changed, and a pressure applied to the sheet sheaf Ps is released.

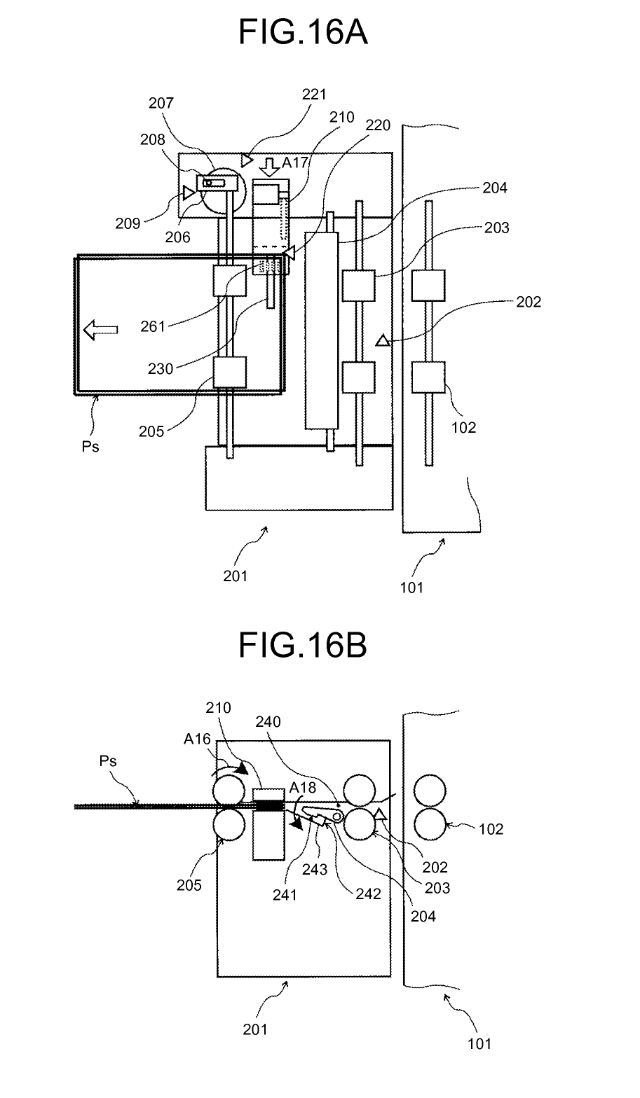

Subsequently, referring to FIGS. 16A and 16B, the sheet discharging rollers 205 rotate in the direction indicated by arrow A16 in the drawing, thereby conveying the sheet sheaf Ps a distance which brings the sheet sheaf Ps to a position where the crimping toothed jaws 261 of the binding tool 210 positionally coincides with a position (binding position) where the sheet sheaf Ps is to be processed, and stop. The crimping toothed jaws 261 of the binding tool 210 are positionally coincided with the position (binding position) where the sheets are to be processed in the sheet conveying direction in this manner. The binding tool 210 is moved in a direction indicated by arrow A17 in the drawing a distance which brings the binding tool 210 to the position where the crimping toothed jaws 261 of the binding tool 210 positionally coincides with the position where the sheets are to be processed, and stopped. The crimping toothed jaws 261 of the binding tool 210 are positionally coincided with the position (binding position) where the sheets are to be processed in the sheet width direction in this manner. At this time, the bifurcating claw 204 is rotated in the direction indicated by arrow A18 (counterclockwise) in the drawing. As a result, the orientation of the distal end of the bifurcating claw 204 is changed, and the bifurcating claw 204 returns to a sheet receiving state. Thereafter, the drive motor 265 of the binding tool 210 is switched on, and the crimping toothed jaws 261 press and squeeze the sheet sheaf Ps, thereby entangling fibers of the sheets P with each other to join the sheets together and binding the sheet sheaf Ps.

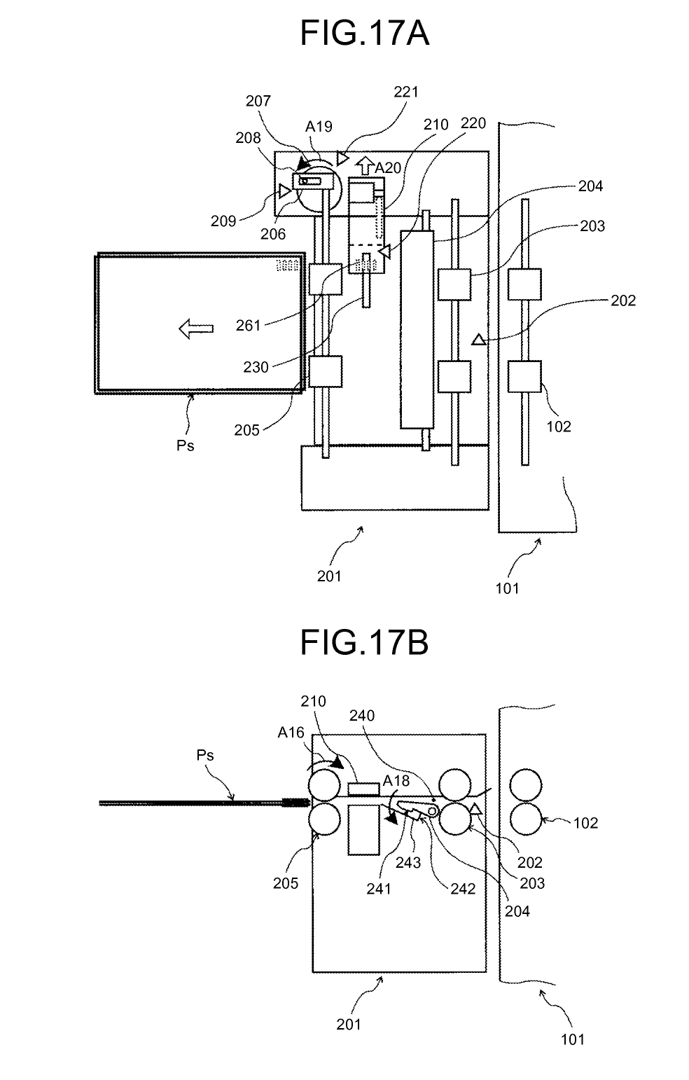

Subsequently, referring to FIGS. 17A and 17B, the sheet discharging rollers 205 further rotate in the direction indicated by arrow A16 in the drawing to discharge the bound sheet sheaf Ps. After the sheet sheaf Ps has been discharged, the shift cam 207 rotates in a direction indicated by arrow A19 in the drawing to return to its home position. The binding tool 210 is moved in a direction indicated by arrow A20 to return to its home position. Hence, the operation of binding the sheet sheaf Ps is completed.

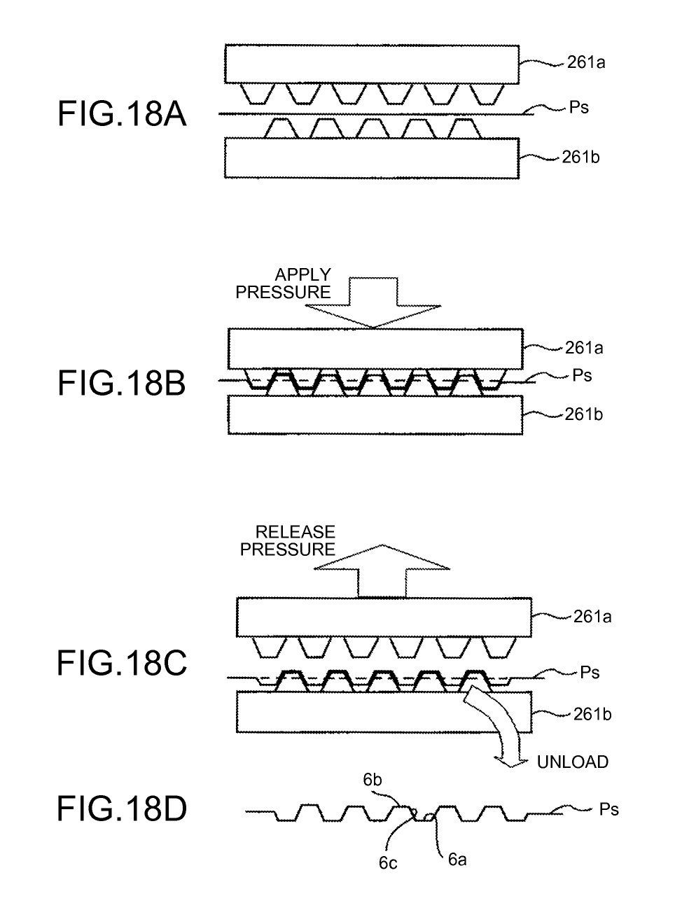

FIGS. 18A to 18D are explanatory diagrams of a crimping binding method.

As illustrated in FIG. 18A, the binding tool 210 is positioned in such a manner that the upper crimping toothed jaw 261a and the lower crimping toothed jaw 261b, each having a shape with protrusions and recesses, face each other so as to pinch the sheet sheaf Ps therebetween. As illustrated in FIG. 18B, at least one of the crimping toothed jaws is moved to engage the upper crimping toothed jaw 261a and the lower crimping toothed jaw 261b with the sheet sheaf Ps therebetween, thereby applying a pressure to the sheet sheaf Ps. As the pressure is increased, fibers of paper are entangled, causing the sheet sheaf Ps to be bound. In this crimping binding, the sheet sheaf Ps can be bound by fibers being entangled and adhering between the sheets by crimping and squeezing the sheet Ps by fitting protrusions and recesses, thereby f.

Thereafter, as illustrated in FIG. 18C, at least one of the crimping toothed jaws is moved again to separate the upper crimping toothed jaw 261a and the lower crimping toothed jaw 261b away from each other. The shape with protrusions and recesses is imprinted into the crimping-bound sheet sheaf Ps as illustrated in FIG. 18D.

In the embodiment, the shape with protrusions and recesses of each of the upper crimping toothed jaw 261a and that of the lower crimping toothed jaw 261b has slope portions slanted at arbitrary angle. The upper crimping toothed jaw 261a and the lower crimping toothed jaw 261b are configured such that when engaged, top portions of the upper crimping toothed jaw 261a do not contact bottom portions of the lower crimping toothed jaw 261b. With this configuration, the sheet sheaf Ps is to be crimping-bonded by the slope portions of the shapes with protrusions and recesses of the upper crimping toothed jaw 261a and the lower crimping toothed jaw 261b. As illustrated in FIG. 18D, recesses 6a of the sheet sheaf Ps are portions squeezed and extended by the protrusions of the upper crimping toothed jaw 261a. Protrusions 6b of the sheet sheaf Ps are portions squeezed and extended by the protrusions of the lower crimping toothed jaw 261b. Slope portions 6c of the sheet sheaf Ps are portions bound by crimping.

The shapes with protrusions and recesses of the pair of crimping toothed jaws, which are a feature of the embodiment, are described below. The upper crimping toothed jaw 261a and the lower crimping toothed jaw 261b are identical in shape. Accordingly, only the lower crimping toothed jaw 261b is described below.

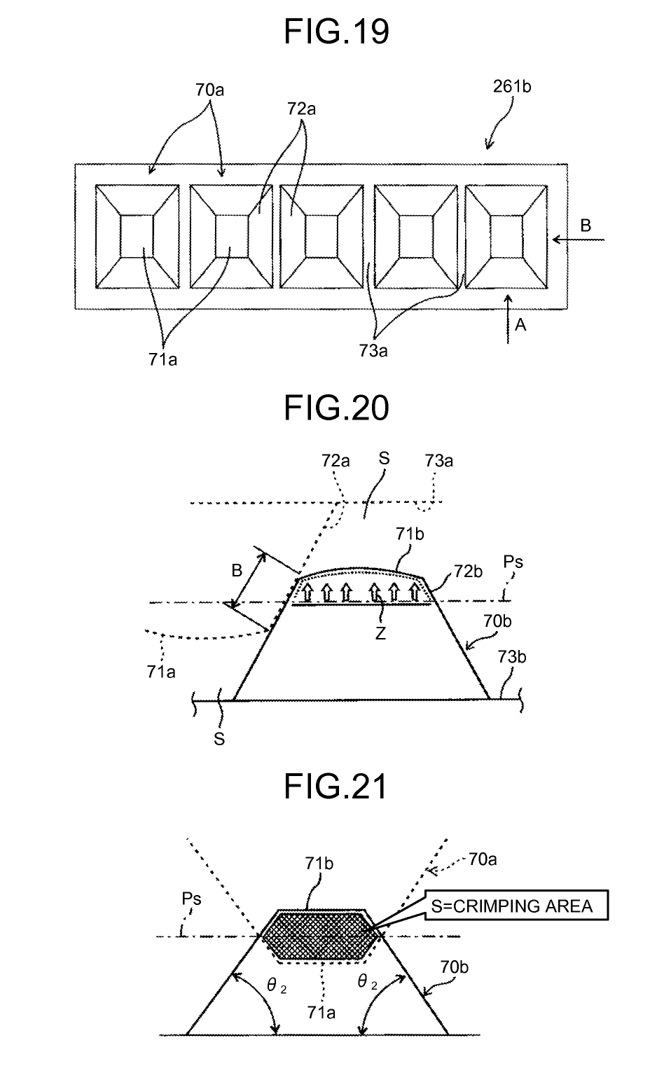

FIG. 19 is a plan view of the lower crimping toothed jaw 261b. FIG. 20 is a diagram of the lower crimping toothed jaw 261b as viewed in a direction A of FIG. 19. FIG. 21 is a diagram of the lower crimping toothed jaw 261b as viewed in a direction B of FIG. 19. The dashed lines in FIGS. 20 and 21 indicate the upper crimping toothed jaw 261a. The long dashed short dashed lines indicate the sheet sheaf Ps.

As illustrated in FIG. 19, the lower crimping toothed jaw 261b has the shape with protrusions and recesses formed by arranging multiple protrusions 70b at predetermined intervals.

Each of the protrusions 70b has a shape obtained by cutting a quadrangular pyramid near a height center parallel to a base of the pyramid and removing the upper portion. Top portions 71b of the protrusions 70b are faces parallel to sheet surface of the sheet sheaf. Meanwhile, “face parallel to the sheet surface” encompasses faces substantially parallel to the sheet surface and slightly-protruding faces such as that illustrated in FIG. 20. Each of the protrusions 70b has four side faces, each having a base side being one of sides of the base of the protrusion 70b and a top side being one of sides of the top face of the protrusion 70b. The four side faces are configured as slope portions 72b slanted relative to the sheet surface of the sheet sheaf Ps.

In FIG. 20, B denotes a crimping height which indicates a contact area between the slope portion 72b of the lower crimping toothed jaw 261b and slope portion 72a of the upper crimping toothed jaw 261a. Arrows Z in FIG. 20 indicate a portion where sheets are extended by the protrusions 70b. In FIG. 21, θ₂ denotes a slope angle which is 60 degrees in the embodiment. In FIG. 21, S denotes a crimping area where sheets are to be crimped.

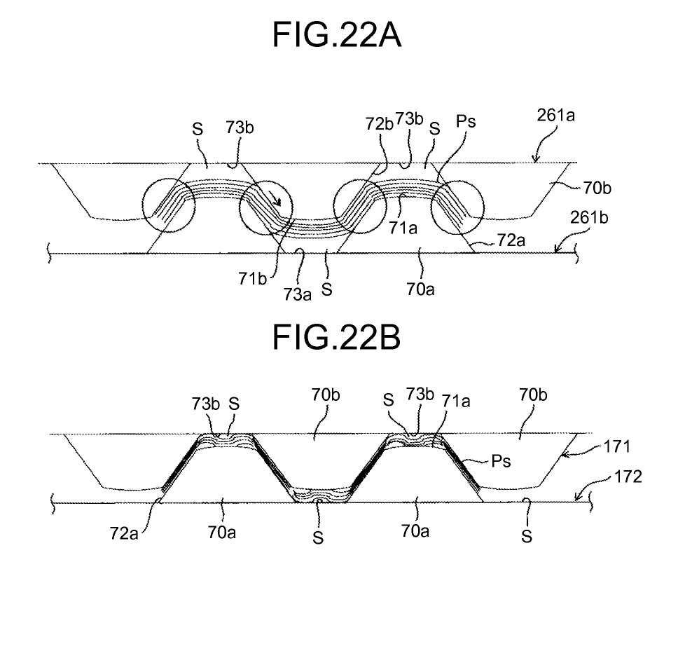

FIGS. 22A and 22B are diagrams describing behavior of the sheet sheaf Ps during crimping binding.

As illustrated in FIG. 22A, one of the crimping toothed jaws is moved to engage the upper crimping toothed jaw 261a and the lower crimping toothed jaw 261b with the sheet sheaf Ps therebetween. The sheets are squeezed and extended by top portions 71a and the top portions 71b of the protrusions of the crimping toothed jaws. In the embodiment, the top portions 71a and 71b of the protrusions of the crimping toothed jaws are configured as faces parallel to the sheet surface of the sheet sheaf Ps. Accordingly, a pressure applied from the top portions 71a and 71b of the protrusions of the crimping toothed jaws to the sheet sheaf Ps can be suppressed to be low. As a result, occurrence of an undesirable situation that the top portions 71a and 71b of the protrusions break the sheet sheaf Ps can be reduced.

In the process in which the upper crimping toothed jaw 261a and the lower crimping toothed jaw 261b are engaged, portions (enclosed by circles in FIG. 22A) of the sheet sheaf Ps pinched between the slope portions 72a, which are the side faces of protrusions 70a of the upper crimping toothed jaw 261a, and the slope portions 72b of the lower crimping toothed jaw 261b are drawn and compressed, causing fibers to be entangled with each other.

In the embodiment, sheets are crimped at the slope portions 72a and 72b which are slanted relative to the sheet surface of the sheet sheaf Ps. When a vertically-upward pressure applied from the slope portion 72b of the lower crimping toothed jaw 261b is decomposed to a component in a direction orthogonal to the slope portion 72b and a component in a direction parallel to the slope portion 72b, the component parallel to the slope portion 72b is directed toward the top portion 71b of the lower crimping toothed jaw 261b. Similarly, when a vertically-downward pressure applied from the slope portion 72a of the upper crimping toothed jaw 261a is decomposed, a component parallel to the slope portion 72a is directed toward the top portion 71a of the upper crimping toothed jaw 261a. Accordingly, at the crimping portions of the sheet sheaf Ps indicated by the circles in FIG. 22A, sheets closer to the lower crimping toothed jaw move up along the slope portions 72b, while sheets closer to the upper crimping toothed jaw move down along the slope portions 72a. These motions cause the sheets to be grinded at the crimping portions of the sheet sheaf Ps, and the fibers of the sheets to be more entangled, thereby allowing the sheets to be bound with a greater binding force.

As illustrated in FIG. 22B, the crimping toothed jaws 261 are configured so that the clearance S is left both between the top portions 71b of the protrusions 70b of the lower crimping toothed jaw 261b and bottom portions 73a of recesses of the upper crimping toothed jaw 261a and between the top portions 71a of the protrusions 70a of the upper crimping toothed jaw 261a and bottom portions 73b of recesses of the lower crimping toothed jaw 261b when the upper crimping toothed jaw 261a is moved to its bottom dead center. As described above, in the embodiment, at the crimping portions of the sheet sheaf Ps indicated by the circles in FIG. 21A, the sheets closer to the lower crimping toothed jaw move up along the slope portions 72b, while the sheets closer to the upper crimping toothed jaw move down along the slope portions 72a. The sheets are moved while being grinded at the crimping portions in this manner. Accordingly, as illustrated in FIG. 22B, the sheets are deflected in a corrugated fashion in the clearance S between the top portions 71a and 71b of the protrusions and the bottom portions 73a and 73b of the recesses. In a configuration where, in contrast to the embodiment, the clearance S is not left but top portions of protrusions are brought into contact with bottom portions of recesses, deflected portions of sheets produced between the top portions of the protrusions and the bottom portions of the recesses are to be eventually compressed, resulting in wrinkles or a like damage of the sheets. However, the embodiment is configured such that, when the upper crimping toothed jaw 261a is moved to its bottom dead center, the clearance S is left between the top portions 71a and 71b of the protrusions and the bottom portions 73a and 73b of recesses. Accordingly, corrugated portions of the sheets are not compressed. Furthermore, according to the embodiment, because the sheets are appropriately pressed by being squeezed by the protrusions 70a and 70b, fibers of the sheets are entangled with each other in the clearance S between the top portions 71a and 71b of the protrusions and the bottom portions 73a and 73b of the recesses. As a result, the sheet sheaf can be bound firmly.

Furthermore, when a pressure is applied to the sheet sheaf Ps from the slope portions 72a and 72b, the sheets can move to the clearance S while being grinded. Accordingly, the sheets can be favorably grinded at the crimping portions, and a favorable binding force can be obtained.

In the embodiment, crimping binding of the sheet sheaf Ps is performed by entangling fibers of paper by squeezing and extending the sheets of the sheet sheaf Ps using the protrusions 70a and 70b and grinding the sheets at the crimping portions indicated by circles in FIG. 22A. As the crimping height B, which indicates the contact area between the slope portion 72b of the lower crimping toothed jaw 261b and the slope portion 72a of the upper crimping toothed jaw 261a, illustrated in FIG. 20 increases, the crimping area S (see FIG. 21) increases, causing a sheet sheaf to be bound firmly. However, as the crimping height B increases, the length between the top portions 71b of the protrusions of the lower crimping toothed jaw 261b to the top portions 71a of the protrusions of the upper crimping toothed jaw 261a in a state where the crimping toothed jaws 261 are engaged increases. As a result, sheets are to be extended longer, and thus sheet breakage resulting from extending the sheets beyond their limit can occur.

To avoid such an undesirable situation, the inventors intensively conducted a verification test and found an optimum value of the crimping height B. The verification test conducted by the inventors is described below.

The verification test was performed by producing a binding tool with the crimping height B of 0.45 mm, a binding tool with the crimping height B of 0.6 mm, and a binding tool with the crimping height B of 0.7 mm and measuring binding forces using each of the binding tools. Meanwhile, it is typical to bind a sheet sheaf of about five sheets. Accordingly, the binding forces were measured by binding a sheet sheaf of five sheets with each of the binding tools.

The following are other conditions of the binding tools:

Applied pressure: 2,000 N,

Number of teeth: six (the number of the protrusions), and

Slope angle θ₂: 60°.

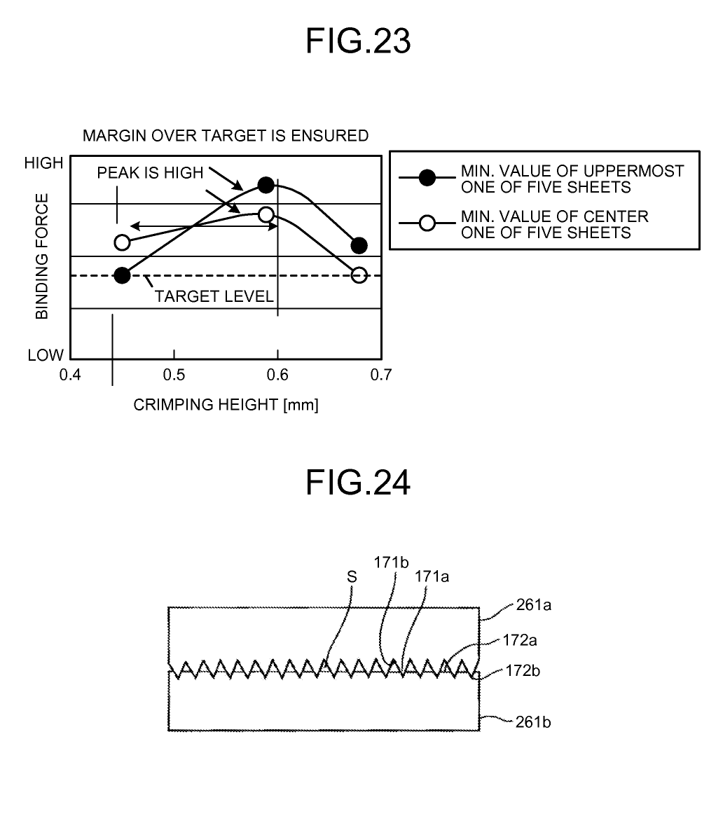

FIG. 23 is a graph illustrating a result of the verification test. FIG. 23 illustrates a result of binding force applied to the first sheet (uppermost sheet) of a sheet sheaf and that applied to a center sheet (the third-from-top sheet) of a sheet sheaf. In FIG. 23, minimum values of the binding force obtained by performing measurement multiple times are plotted.

Referring to FIG. 23, when the crimping height B is equal to or longer than 0.45 mm, a binding force equal to or higher than a target level can be achieved. The binding force peaks at the crimping height B of 0.6 mm. The binding tool with the crimping height B of 0.7 mm is lower in binding force than the binding tool with the crimping height B of 0.6 mm. Because sheet breakage decreases the binding force, the reason why even though the crimping height B is higher than 0.6 mm, the binding force of the binding tool with the crimping height B of 0.7 mm is lower is presumably that one or more of sheets bound with the binding tool with the crimping height B of 0.7 mm were broken.

From the verification test, it is found that at least setting the crimping height B to be equal to or longer than 0.45 mm and equal to or shorter than 0.6 mm allows a favorable binding force to be obtained without causing sheet breakage.

Even when the crimping height is shorter than 0.45 mm, a binding force equal to or higher than the target level can be achieved by increasing the number of teeth (the number of the protrusions) or increasing the applied pressure. However, increasing the number of teeth increases the size of the binding tool, which leads to an increase in cost of materials and, eventually, to an increase in cost of the apparatus. Furthermore, consuming more materials can be waste of resources. Increasing the pressure requires that a drive force supplied from a driving source to apply the pressure be increased. This disadvantageously increases electric power consumption of the apparatus. However, by setting the crimping height B to be equal to or longer than 0.45, increases in the number of teeth and the cost of materials can be reduced, thereby reducing an increase in cost of the apparatus. Moreover, resources saving can be achieved. Still furthermore, because a lower pressure is required, energy saving can be achieved.

The embodiment described above is an example. Advantages each specific to the following aspects are provided.

### First Aspect

According to a first aspect of the present invention, a crimping-binding-type sheet binding device, an example of which is the binding tool 210, includes a pair of crimping members each including alternately-arranged multiple recesses and multiple protrusions, the protrusions and the recesses of one the pair of crimping members being arranged in the direction along which the protrusions and the recesses of the other one of the pair of crimping members are arranged, to bind a sheaf of sheets by fitting the recesses and the protrusions with the sheet sheaf interposed therebetween. The pair of crimping members is configured as follows. The top portions 71a and 71b of the protrusions of each of the pair of crimping members are faces parallel to a sheet surface of the sheet sheaf. Side faces of the protrusions are slanted faces, an example of which is the slope portions 72a and 72b, slanted relative to the sheet surface. When the recesses and the protrusions of the pair of crimping members are fitted, the slanted faces of one of the pair of crimping members and the slanted faces of other one of the pair of crimping members are in contact with each other with the clearance S left both between the top portions 71a of the protrusions of the one of the crimping members and the bottom portions 73b of the recesses of the other one of the crimping members and between the top portions 71b of the protrusions of the other one of the crimping members and the bottom portions 73a of the recesses of the one of the crimping members.

According to the first aspect, when the pair of crimping members is engaged, the slanted faces, which are the side faces of the protrusions of the pair of crimping members, are brought into contact with each other. Accordingly, the sheet sheaf is bound by a pressure applied from the slope portions of the pair of crimping members. In the engaged state, the clearance is left both between the top portions of the protrusions of the one of the crimping members and the bottom portions of the recesses of the other one of the crimping members and between the top portions of the protrusions of the other one of the crimping members and the bottom portions of the recesses of the one of the crimping members. Accordingly, further reduction in load placed on fibers of paper can be achieved than that of the configuration disclosed in international publication No. WO 2009/110298, in which a clearance is left only between top portions of protrusions of one of crimping members and bottom portions of recesses of other one of the crimping members. Thus, according to the first aspect, fibers are more likely prevented from being extended beyond their limit than the configuration of international publication No. WO 2009/110298, entanglement between fibers can be achieved with less sheet breakage than with the configuration of international publication No. WO 2009/110298.

Furthermore, according to the first aspect, the top portions of the protrusions of both of the crimping members are faces parallel to the sheet surface of the sheet sheaf. Accordingly, both of contact between the sheet sheaf and the top portions of the protrusions of the one of the crimping-binding toothed jaws and contact between the sheet sheaf and the top portions of the protrusions of the other one of the crimping-binding toothed jaws are made by area contact, and therefore pressure concentration is prevented. As a result, occurrence of an undesirable situation that a sheet sheaf is broken during crimping binding can be reduced.

### Second Aspect

According to a second aspect of the present invention, in the sheet binding device according to the first aspect, a length (the crimping height B) of a contact portion where the slanted faces are in contact with each other as viewed from a direction parallel to the sheet surface and orthogonal to the direction along which the recesses and the protrusions are arranged is equal to or longer than 0.45 mm and equal to or shorter than 0.6 mm.

According to the second aspect, as described in the foregoing verification test, setting the length (the crimping height B) of the contact portion where the slanted faces are in contact with each other to be equal to or longer than 0.45 mm and equal to or shorter than 0.6 mm allows a favorable binding force to be obtained while reducing sheet breakage.

### Third Aspect

According to a third aspect of the present invention, the sheet processing apparatus 201 including at least a sheet binding device, such as the binding tool 210, configured to perform a binding process on the sheet sheaf Ps includes, as the sheet binding device, the sheet binding device according to the first aspect or the second aspect.

According to the third aspect, as described above in the embodiment, favorable binding force can be obtained while reducing sheet breakage.

### Fourth Aspect

According to a fourth aspect of the present invention, the image forming system 100 including the image forming apparatus 101 configured to form an image on a sheet, and a sheet binding device, an example of which is the binding tool 210, configured to perform a binding process on a sheaf of sheets on which an image is formed by the image forming apparatus 101 includes the sheet binding device according to the first aspect or the second aspect as the sheet binding device.

According to the fourth aspect, binding a sheaf of sheets on which an image is formed can be achieved with favorable binding force while reducing sheet breakage.

According to an embodiment, damage to a sheet(s) can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A crimping-binding-type sheet binding device comprising:
a pair of crimping members each including alternately-arranged multiple recesses and multiple protrusions, the protrusions and the recesses of one of the pair of crimping members being arranged in a direction parallel to a direction in which the protrusions and the recesses of other one of the pair of crimping members are arranged, to bind a sheaf of sheets by fitting the recesses and the protrusions with the sheet sheaf interposed therebetween, wherein
the pair of crimping members are configured in such a manner that
top portions of the protrusions of each of the pair of crimping members are faces parallel to a sheet surface of the sheet sheaf,
side faces of the protrusions of each of the pair of crimping members are slanted faces slanted relative to the sheet surface, and
when the recesses and the protrusions of the pair of crimping members are fitted, the slanted faces of the one of the pair of crimping members and the slanted faces of the other one of the pair of crimping members are in contact with each other with a clearance left both between the top portions of the protrusions of the one of the crimping members and bottom portions of the recesses of the other one of the crimping members and between the top portions of the protrusions of the other one of the crimping members and bottom portions of the recesses of the one of the crimping members.

2. The sheet binding device according to claim 1, wherein a length of a portion where the slanted faces are in contact with each other, as viewed from a direction parallel to the sheet surface and orthogonal to the direction along which the recesses and the protrusions are arranged is equal to or longer than 0.45 mm and equal to or shorter than 0.6 mm.

3. A sheet processing apparatus comprising
at least a sheet binding device configured to perform a binding process on a sheaf of sheets, wherein
the sheet binding device according to claim 1 is used as the sheet binding device.

4. An image forming system comprising:
an image forming apparatus configured to form an image on a sheet; and
a sheet binding device configured to perform a binding process on a sheaf of sheets on which an image is formed by the image forming apparatus, wherein
the sheet binding device according to claim 1 is used as the sheet binding device.
